(19) United States
(12) Patent Application Publication
(10) Pub. No.: US 2005/0283413 A1
(43) Pub. Date: Dec. 22, 2005

(54) Unified antitrust analysis

(76) Inventor: Joseph J. Simons, McLean, VA (US)

Correspondence Address: Larry A. Coury;Paul, Weiss, Rifkind, Wharton & Garrison, LLP, 1285 Avenue of the Americas, New York, NY, 10019, US

(21) Appl. No.: 11/152,714

(22) Filed: Jun. 14, 2005

Related U.S. Application Data
(60) Provisional application No. 60/581,144, filed on Jun. 17, 2004.

(51) Int. Cl. G06F 17/60

(52) U.S. Cl. 705/30

(57) ABSTRACT

Section 7 of the Clayton Act, 15 USC § 18, prohibits mergers that substantially lessen competition, which has generally been interpreted to prohibit mergers that reduce consumer welfare. Determining whether consumer welfare is reduced in any particular market requires a balancing of the procompetitive and anticompetitive effects of the transaction. The present invention provides a method for analyzing mergers and balancing the efficiencies and anticompetitive effects to determine whether a merger is overall beneficial or neutral for consumer welfare. The method utilizes the risk-adjusted, net present value (NPV) for both the competitive effects and the efficiencies of the merger then determines whether a particular merger should be challenged as anticompetitive based on an analysis of this NPV.

### RELATED U.S. APPLICATION DATA

This application claims priority to provisional U.S. application No. 60/581,144 filed Jun. 17, 2004.

### BACKGROUND OF THE INVENTION

Governmental regulation of anticompetitive behavior dates back more than 100 years. The first measure passed by the federal government to prohibit unfair methods of competition was the Sherman Antitrust Act of 1890. Prior to its enactment, anticompetitive behavior was regulated by similar state laws that were limited to intrastate commerce. The Sherman Act declared illegal every contract, combination, or conspiracy in restraint of interstate and foreign trade and authorized the federal government to institute proceedings to enforce the laws and eliminate anticompetitive behavior.

In 1914 the Sherman Act was supplemented by the Clayton Antitrust Act which established the Federal Trade Commission (FTC) to enforce the provisions of the Clayton Act. The Clayton Act provides the analytical framework for the method of analyzing mergers described by the present invention.

The Robinson-Patman Act was later passed by the federal government in 1936 to supplement the Clayton Act. Robinson-Patman forbade any person engaged in interstate commerce from discriminating among different purchasers of the same commodity based on price if the effect was to substantially lessen competition, or to tend to create a monopoly.

The federal government has issued numerous additional guidelines since these Acts were passed. The first such guidelines were issued in 1968 from the Antitrust Division of the U.S. Department of Justice (DOJ). These Merger Guidelines were revised by the DOJ in 1982 and amended in 1984 (U.S. Department of Justice, Merger Guidelines (1984), reprinted in 4 Trade Reg. Rep. (CCH) ¶ 13,103) when the Federal Trade Commission (FTC) joined in the issuance of the Guidelines. Since that time, the DOJ and FTC have amended the Guidelines twice more, in April 1992 and again in April 1997 (U.S. Department of Justice & Federal Trade Commission, Horizontal Merger Guidelines, reprinted in 4 Trade Reg. Rep. (CCH) ¶ 13,104).

The 1982 DOJ Merger Guidelines recognized the importance of first principles, namely, prohibiting transactions that significantly create or enhance the exercise of market power, either by creating a dominant firm or by enabling multiple firms to engage in tacit or overt collusion. The explanation accompanying the 1982 Guidelines specifically stated that the Guidelines' market definition was meant to identify and consider all firms that would have to cooperate in order to raise prices above competitive levels and keep them there. Thus, the market definition was geared precisely to accomplish the ultimate goal of the Guidelines: to prevent one of a few firms from dominating the market. The section of the Guidelines dealing with Ease of Entry was similarly focused, looking to whether “entry into the market is so easy that existing competitors could not succeed in raising price for any significant period of time.”

The method described herein may be better understood if certain terms are explicitly defined. The Relevant Market is defined to be a product or group of products such that a hypothetical profit-maximizing firm that was the only present and future seller of those products (“monopolist”) likely would impose at least a “small but significant and nontransitory” increase in price. The Relevant Market includes the suppliers of the same or related product in the same or related geographic area whose existence significantly restrains the potential monopolizer's power.

Another important factor to be considered in merger analysis is Ease of Entry for firms after a merger. A merger is not likely to create or enhance market power for a monopolist or a few market participants if entry into the market is easy enough so that, after the merger, the monopolist or market participants could not profitably maintain a price increase above premerger levels. Entry is sufficiently easy if entry would be timely, likely, and sufficient in its magnitude, character and scope to deter or counteract any anticompetitive effects of the merger. The DOJ Merger Guidelines define “committed entry” as new competition that requires expenditure of significant costs of entry and exit. A three step methodology is used to assess whether committed entry would deter or counteract a competitive effect of concern.

The first step assesses whether entry can achieve significant market impact within a timely period. If significant market impact would require a longer period, entry will not deter or counteract the competitive effect of concern.

The second step assesses whether committed entry would be a profitable and likely response to a merger having anticompetitive effects. Firms considering entry that requires significant costs must evaluate the profitability of the entry on the basis of long term participation in the market since resources will be committed for a significant length of time. Entry that is sufficient to counteract the anticompetitive effects will cause prices to fall to their premerger levels or lower. Thus, the profitability of such committed entry must be determined on the basis of premerger market prices over the long-term.

The third step assesses whether timely and likely entry of other firms into the market would be sufficient to return prices to their premerger levels. This may include either entry of multiple firms or entry of one firm at a sufficient scale. Entry may not be sufficient, even though timely and likely, where the constraints on availability of essential assets make it impossible for entering firms to achieve profitability. For example, established firms may block access to the market by controlling the supply of essential raw materials, necessary patents, distribution channels, or other strategic factors make entry either impractical or impossible because of the cost of entry. Regulations may also limit entry of new competitors. In addition, the character and scope of entrants' products might not be fully responsive to the opportunities created when direct competition among sellers of differentiated products is eliminated, thus creating another barrier to entry. That is, product differentiation may be difficult because high promotional costs may be required to counteract established brand loyalty. In assessing whether entry will be timely, likely, and sufficient, the FTC recognizes that precise and detailed information may be difficult or impossible to obtain. In such instances, the FTC (and consequently the presently described method) will rely on all available evidence bearing on whether entry will satisfy the conditions of timeliness, likelihood, and sufficiency.

Applying the Guidelines to mergers should involve analyzing the procompetitive or anticompetitive effects on price as well as any efficiencies that result from eliminating redundant activities following the merger. Merger-generated efficiencies may result when, for example, the merger enhances competition by permitting two relatively inefficient (e.g., high cost) competitors to become one more efficient (e.g., lower cost) competitor in the marketplace. Efficiencies have historically been among the most frustrating issues facing the merging companies and their antitrust counsel. At the outset of modern antitrust merger law, efficiencies were an offense—not a defense. The impact of efficiencies still remained minimal under the 1982 DOJ Merger Guidelines which stated that efficiencies would be considered only in “extraordinary cases,” and that the efficiencies defense required proof of “substantial cost savings” by “clear and convincing evidence.” (1982 DOJ Guidelines, § V.A.) Slowly over time, this situation has been reversed as economic analysis increased its significance in antitrust jurisprudence. But merger efficiencies still remain a fairly neglected component in the analysis of antitrust law and economics.

It is well known that the Federal agencies and courts that enforce the antitrust laws focus the overwhelming majority of their attention during merger analysis on market definition and the magnitude and timing of competitive effects, such as price effects. Efficiencies are evaluated but they almost never seem to be significant to the outcome. As former FTC Chairman Timothy J. Muris has observed, “[t]oo often, the Agencies found no cognizable efficiencies when anticompetitive effects were determined to be likely and seemed to recognize efficiency only when no adverse effects were predicted.” (T. Muris, “The Government and Merger Efficiencies: Still Hostile After All These Years,” 7 Geo. Mason L. Rev. 729, 731 (1999)). Thus, efficiencies have not played an important role in merger analysis. Their only real significance today is to provide evidence that something other than market power motivated the merger transaction, which makes the enforcement authorities more comfortable concluding that no anticompetitive effects are likely.

Efficiencies have thus not received appropriate treatment and this failure stems primarily from the lack of a means to balance them against potential anticompetitive effects. Because the tools do not exist to adequately account for efficiencies, merging parties and their counsel run a greater risk that a merger will be challenged by regulatory agencies. The present invention solves this existing problem by providing a method for analyzing mergers that appropriately accounts for the effect of efficiencies and provides a quantitative basis for determining whether a particular merger will increase or reduce consumer welfare.

The method of this invention provides a tighter focus on the first principles of merger analysis with respect to efficiencies. The quantitative aspect of this invention may increase the significance of efficiencies by exposing the discriminatory treatment historically given to them compared to competitive effects. In addition, by making the assumptions underlying the analysis more transparent, the rigor of the overall merger analysis may improve. Therefore, the merger analysis method of the present invention provides a benefit both to merging parties and to the regulatory agencies that monitor mergers for the public, since this analysis provides a more accurate accounting of efficiencies and provides a transparent calculation that can be used to determine whether the merger will increase or reduce consumer welfare.

### SUMMARY OF THE INVENTION

The present invention provides a method for determining whether the benefits for a merger outweigh the costs by calculating a risk-adjusted net present value (NPV) wherein the calculation consists essentially of:
(A) Calculating the weighted magnitude of any anticompetitive effect on price in the years following the merger by:
   1. defining the Relevant Market for antitrust purposes,
   2. defining the Ease of Entry for suppliers into the defined market,
   3. defining a raw numerical value for the anticompetitive effect on price that results from the merger,
   4. calculating a weighted magnitude for the anticompetitive effect on price by defining a weighting value that is multiplied by the raw value for the anticompetitive effect on price;
   5. calculating a total competitive effect by finding the product of the probability that the market definition is correct, the probability of entry into the defined market, and the weighted magnitude of the anticompetitive effect on price for each year following the merger but prior to entry into the market; and
(B) calculating the weighted magnitude of efficiencies by:
   1. calculating a raw numerical value for the marginal cost of producing an item in the defined market,
   2. calculating a raw value for the pecuniary benefit for the merger,
   3. calculating a raw fixed cost benefit of the merger,
   4. calculating a weighted magnitude for the marginal cost, pecuniary benefit, and fixed cost benefit by defining a weighting value for each of said efficiencies that is multiplied by the raw value for each of said efficiencies;
(C) calculating the risk-adjusted NPV by summing the weighted magnitude of the anticompetitive effects and the weighted magnitudes for the marginal cost, pecuniary benefit, and fixed cost benefit for each year following the merger in which the calculation is performed;
   wherein positive values for the risk-adjusted NPV in a given year represent situations where the benefits for a merger outweigh the costs, and wherein negative values for the risk-adjusted NPV in a given year represent situations where the benefits for a merger do not outweigh the costs.

The method also explicitly includes the use of a computer to calculate values required for the method of analysis or to perform the method itself. One will appreciate that various methods of calculating or estimating the values required for the method of analysis are known. However, the exact method of calculation will vary depending on the information that is known about a particular market or merger. In addition, no quantitative method currently exists to calculate the overall competitive effects of mergers as a whole. Therefore, the method of analysis described by the present invention lends itself to a computer-based calculation that can be extended as both the methods of calculating the required values are improved and the methods for calculating the overall competitive effects of mergers are improved.

### DETAILED DESCRIPTION OF THE INVENTION

The first principle for consideration under the merger analysis of the present invention—prohibiting mergers that reduce consumer welfare—applies equally to competitive effects and efficiencies. The ultimate goal of this analysis is to predict the overall effects of a merger over the reasonably foreseeable future. Although this is difficult to do in practice, the presently described merger analysis provides a quantitative method with predictive value that may be used to categorize a particular merger as either enhancing or reducing consumer welfare. The method of this invention may instigate the development of better tools for merger analysis over time if there is a perceived need for such tools. Development of better tools has already been initiated for market definition and competitive effects analysis contained in the Guidelines previously issued by the DOJ and FTC.

To determine whether the overall effect of a merger will reduce consumer welfare or not, the method of this invention utilizes a risk adjusted (net present value) NPV calculation. The method first requires an estimation of the magnitude of any price effect, where decreases in price improve consumer welfare and increases in price do not. In addition to the magnitude of the price effect, the method requires an estimation of the probability that the price effect will be realized as well as the timing and the duration of the price effect. Similarly, the method requires an estimation of the magnitude, probability of realization, timing, and duration of efficiencies. That is, a person utilizing the merger analysis of the present invention must estimate the magnitude of any efficiencies and their effect on price, the likelihood that they will be realized, their timing and their duration.

The price effect and efficiencies may be estimated based on past history in the same or similarly-defined markets. Sometimes natural experiments within these markets provide information that could be predictive and may be used to estimate the price effect and efficiencies for the purposed of the presently described merger analysis. For example, natural experiments could include information on whether market entry occurred in the past and, if so, under what circumstances. As another example, if geographic markets are less than national, market entry can be analyzed to determine whether it occurred more or less frequently in regions where mergers occurred around the same time. Numerous methods for simulating economic conditions have been developed and may be used to estimate the price effect and efficiencies for the use with the method of this invention.

For example, with respect to static analysis, a method has been developed for determining the marginal cost reductions sufficient to prevent price increases involving unilateral effects for differentiated products, (G. Werden, “A Robust Test for Consumer Welfare Enhancing Mergers among Sellers of Differentiated Products,” 44 J. Indus. Econ. 409 (1996)). For clarification, this article refers to “Nash static equilibrium.” Nash equilibrium is a state where each competitor in a market adopts a strategy that is the best response to the other market competitors' strategies. When Nash static equilibrium exists, no market competitor has an interest to deviate unilaterally.

Others have developed a method for determining price effects for homogeneous products, that is where the Relevant Market contains only one or a few very similar products (L. Froeb & G. Werden, “A Robust Test for Consumer Welfare Enhancing Mergers among Sellers of a Homogeneous Product,” US Dept. of Justice Antitrust Division, Economic Analysis Group Discussion Paper 97-1 (1997)).

Other articles have estimated the minimum pass through for marginal cost reductions. The pass through for marginal cost reduction can be explained as follows. A merger may permit the newly-formed combined company to reduce the marginal cost of producing a product, and this reduction in marginal cost creates an incentive for the company to lower the price to consumers. Not all of the cost savings will in fact be passed through to the consumer, however. Accordingly, the evaluation of the likely competitive effects of a merger or acquisition includes determining the rate at which cost savings are passed through to consumer prices and the magnitude of cost reductions that would result from merger. A 50% pass-through rate means that 50% of the reduction in marginal cost to the producer will be passed-through to the consumer in the form of a reduced price. One such article suggests that 50% should be the minimum pass through for marginal cost reductions (J. Hausman and G. Leonard, “Efficiencies From the Consumer Viewpoint,” 7 Geo. L. Rev. 707 (1999)). Another article on this topic, however, estimates a 21% pass through rate for the merger of two office supplies stores, Office Depot and Staples, (O. Ashenfelter, “Identifying the Firm-Specific Cost Pass-Through Rate,” FTC Bureau of Economics Working Paper No. 217 (1998)).

Another author addressed the impact of fixed cost reductions on price in a presentation at the FTC's Merger Efficiencies Roundtable in December of 2002. In this presentation, the author argued that actual pricing decisions of real world companies are generally impacted by savings in fixed costs, which is contrary to neoclassical economic theory. These references are herein incorporated by reference. A person of ordinary skill in this field will appreciate that numerous other methods exist for estimating price effects and efficiencies, and these methods may be employed when estimating the price effects and efficiencies for use with the merger analysis and method of the present invention.

The probabilities that certain price effects or efficiencies will be realized may be determined by analysis of documents, interviewing and deposing witnesses, econometric analysis, and other methods. Rather than using single numerical estimates for price effects and efficiencies, it may be more appropriate in some cases to estimate ranges for the price effects and efficiencies and calculate the Consumer Welfare NPV within a corresponding range.

The number of years for which the analysis and method is applied will vary with the Relevant Market. For example, the method may be applied further into the future for markets that historically have high barriers to entry, such as steel production and automobile manufacturing, since the markets are less likely to change with time. By contrast, it will be difficult to apply the method as far into the future for a rapidly changing market, like consumer electronics or computer software, because the constantly evolving product line and relatively low barrier to entry make it difficult to make predictions about the market very far into the future.

Using these estimations, the method of the present invention provides a quantitative measure of the expected costs and benefits to consumer over time based upon the NPV calculation. Whether the merger is challenged or not by regulatory authorities should depend on whether the NPV is positive or negative for consumers.

### EXAMPLE 1

A hypothetical potential merger is to occur between two widget producers, and the following market conditions are estimated or determined:
The market definition is widgets with 80% probability
Entry into the market will not occur for 2 years, and such entry will occur with 80% probability
Anticompetitive effects (given the market definition and entry conclusions) are a 10% rise in price for 2 years, and such rise in price will occur with 80% probability
The marginal cost of producing widgets will decline and impact price by 2%, and such a reduction in marginal cost will occur with 70% probability beginning in the second year after the merger and continue through the fifth year after the merger
Pecuniary costs will decline and impact price by 1%, and such a reduction in pecuniary costs will occur with 70% probability beginning in the first year after the merger and continue through the fifth year after the merger.
Fixed costs will decline and impact price by 1%, and such a reduction in fixed costs will occur with 70% probability beginning in the third year after the merger and continue through the fifth year after the merger.

These assumptions are summarized in the following table, which allows the calculation of the NPV for that flow of positive and negative benefits resulting from this hypothetical transaction. For simplicity and clarity, the impacts on price, although expressed as percentages in the text above, are represented as whole number values of the harm or benefit in the table below while probabilities are represented as traditional decimal values. Reporting the impacts on price in decimal form would not change the conclusions that result from application of the method. It shows that even though the merger is projected to raise price by 10% for two years, the net projected effect on consumers is positive. Therefore, the merger described in this example should be permitted by regulatory authorities.

Consumer Welfare NPV Spreadsheet

| | Prob | Harm/Bn | Risk Adj. | Year 1 | Year 2 | Year 3 | Year 4 | Year 5 |
|---|---|---|---|---|---|---|---|---|
| Competitive Effects | | | | | | | | |
| Market Definition | 0.80 | | | | | | | |
| Entry | 0.80 | | | | | | | |
| Anticompetitve Effects | 0.80 | −10 | | | | | | |
| Total | 0.51 | −10.00 | −5.1 | −5.1 | −5.1 | 0.0 | 0.0 | 0.0 |
| Efficiencies | | | | | | | | |
| Marginal Cost | 0.7 | 2 | 1.4 | 0.0 | 1.4 | 1.4 | 1.4 | 1.4 |
| Pecuniary Benefit | 0.7 | 1 | 0.7 | 0.7 | 0.7 | 0.7 | 0.7 | 0.7 |
| Fixed Cost Benefit | 0.7 | 2 | 1.4 | 0.0 | 0.0 | 1.4 | 1.4 | 1.4 |
| Total Effect | | | | −4.4 | −3.0 | 3.5 | 3.5 | 3.5 |
| NPV@ 0.1 | | | | | | | | |
| 0.68 | | | | | | | | |

Although regulatory agencies do not currently engage in a precise mathematical calculation to determine whether to allow particular mergers, the method of the present invention allows analysis of mergers in a broad way, emphasizes the ultimate purpose of the analysis, and perhaps most importantly, renders transparent the assumptions used in the analysis. The transparency of this analysis can expose inconsistencies and flaws, and provide incentives to develop new techniques.

In addition, the methods of the present invention may also be used whenever balancing of competing effects is required under the antitrust laws. For example, Section 1 of the Sherman Act regulates non-merger situations—such as agreements, combinations, and conspiracies that may restrain trade or commerce—as well as certain unilateral conduct. This section of the Sherman Act similarly requires a balancing of efficiences against anticompetitive effects. The principles of the current invention—calculating procompetitive effects and anticompetitive effects then balancing them by calculating the NPV for a particular transaction or situation—would apply equally well to transactions and non-merger situations addressed in the Sherman Act and other antitrust laws.

Among other things, this approach helps to define which efficiencies are cognizable, provides a framework to evaluate them, and instructs on how to weight them. Just as importantly, it does the same for competitive (or anticompetitive) effects on price. The efficiencies and effects on price must then be evaluated relative to each other. The larger, the more likely, and the longer any adverse effects on price are, the larger, the more likely and the longer the offsetting efficiency effects must be to overcome the adverse consequence of increasing price. The relative weighting of the two competing effects is determined by the NPV calculation.

For instance, Example 1 illustrates that efficiencies occurring in the third through the fifth years following a merger can be determinative of the overall result and should not be ignored or dismissed without adequate consideration. Example 1 also shows how the probabilities for the competitive price effects can depend on the market definition and ease of entry, which places an emphasis on the accuracy (or lack thereof) of the anticompetitive effects in many cases. Similarly, Example 1 shows how the probabilities for the efficiencies that are necessary to avoid a reduction in consumer welfare can depend on the estimates for the magnitude and probability of anticompetitive effect.

The method of analysis described in the present invention also suggests something about burdens of proof. If a regulatory agency that is attempting to block a particular merger can marshall facts that, absent efficiencies, demonstrate a harm to consumers, then this agency has presented a prima facie case that the merger should not go forward. If no other evidence (i.e. no efficiencies) is presented by the merging parties, the merger should in fact not go forward. If the merging parties can show that the merger will result in likely efficiencies that prevent the price from rising when the total NPV is considered, the merging parties have demonstrated that the merger will not reduce consumer welfare. If the merging parties produce no additional evidence, the fact finder would have no reason to reach other issues and the inquiry should end at this point. If, however, the regulatory agency provides evidence to refute the efficiencies and/or demonstrate that prices would have been lower because the efficiencies could have been achieved without a merger or through a different, less anticompetitive merger (i.e. that some or all of the efficiencies are not merger specific), then a harm to consumer welfare has been proven and the merger should not go forward.

If the agency is suggesting the efficiencies are not merger specific because another, less anticompetitive transaction could achieve the same efficiencies, then the timing must be considered and the method of the present invention permits this. Given the time it would take to negotiate and execute an alternative transaction, there will usually be a significant difference in timing between initial transaction and the achievement of the efficiencies under an alternative transaction.

There also appears to be a significant desire in the antitrust community to improve the treatment of efficiencies in merger cases. This invention, by creating a general but clear framework, gives the antitrust community direction in which to channel further developments in merger efficiencies analysis.

1. A method for determining whether the benefits for a merger, agreement, combination, or conspiracy regulated by the antitrust laws of the United States outweigh the costs for the same by calculating a risk-adjusted net present value (NPV), wherein the calculation consists essentially of:
(A) Calculating the weighted magnitude of any anticompetitive effect on price in the years following the merger, agreement, combination, or conspiracy by:
1. defining the Relevant Market for antitrust purposes,
2. defining the Ease of Entry for suppliers into the defined market,
3. defining a raw numerical value for the anticompetitive effect on price that results from the merger,
4. calculating a weighted magnitude for the anticompetitive effect on price by defining a weighting value that is multiplied by the raw value for the anticompetitive effect on price;
5. calculating a total competitive effect by finding the product of the probability that the market definition is correct, the probability of entry into the defined market, and the weighted magnitude of the anticompetitive effect on price for each year following the merger, agreement, combination, or conspiracy but prior to entry into the market; and
(B) calculating the weighted magnitude of efficiencies by:
1. calculating a raw numerical value for the marginal cost of producing an item in the defined market,
2. calculating a raw value for the pecuniary benefit for the merger, agreement, combination, or conspiracy,
3. calculating a raw fixed cost benefit of the merger, agreement, combination, or conspiracy,
4. calculating a weighted magnitude for the marginal cost, pecuniary benefit, and fixed cost benefit by defining a weighting value for each of said efficiencies that is multiplied by the raw value for each of said efficiencies;
(C) calculating the risk-adjusted NPV by summing the weighted magnitude of the anticompetitive effects and the weighted magnitudes for the marginal cost, pecuniary benefit, and fixed cost benefit for each year following the merger, agreement, combination, or conspiracy in which the calculation is performed;
wherein positive values for the risk-adjusted NPV in a given year represent situations where the benefits for the merger, agreement, combination, or conspiracy outweigh the costs, and wherein negative values for the risk-adjusted NPV in a given year represent situations where the benefits for the merger, agreement, combination, or conspiracy do not outweigh the costs.

2. The method according to claim 1 wherein a computer is used to calculate one or more of the values selected from the group consisting of the Relevant Market, Barrier to Entry, anticompetitive effect on price, marginal cost, pecuniary benefit, and fixed cost benefit.

3. The method according to claim 1 wherein a computer is used to calculate one or more of the values selected from the group consisting of total competitive effect, weighted magnitude for the marginal cost, weighted magnitude for the pecuniary benefit, and weighted magnitude for the fixed cost benefit.

4. The method according to claim 1 wherein a computer is used to calculate the risk-adjusted NPV.

5. The method of claim 1 used to determine whether the benefits for a merger regulated by the antitrust laws of the United States outweigh the costs for the same.

6. The method of claim 1 used to determine whether the benefits for an agreement regulated by the antitrust laws of the United States outweigh the costs for the same.

7. The method of claim 1 used to determine whether the benefits for a combination regulated by the antitrust laws of the United States outweigh the costs for the same.

8. The method of claim 1 used to determine whether the benefits for a conspiracy regulated by the antitrust laws of the United States outweigh the costs for the same.
